(19) United States
(12) Patent Application Publication
(10) Pub. No.: US 2010/0288636 A1
(43) Pub. Date: Nov. 18, 2010

(54) Laminated gas sensor and method of producing the same

(75) Inventors: Masahiro Sone, Nagoya-city (JP); Manabu Tomisaka, Nagoya-city (JP); Masashi Totokawa, Nagoya-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/800,285

(22) Filed: May 12, 2010

(30) Foreign Application Priority Data
May 15, 2009 (JP) 2009-119209

(51) Int. Cl. G01N 27/26; B05D 5/12

(52) U.S. Cl. 204/424; 427/58

(57) ABSTRACT

A laminated gas sensor for exhaust gases improving thermal shock resistance, durability and reliability without permitting characteristics of the exhaust gas sensor to be particularly lowered is provided. A laminated gas sensor comprising a solid electrolyte layer (4) formed on one surface of a substrate (1) holding a lower electrode layer (3) therebetween, and an upper electrode layer (5) on the solid electrolyte layer (4), wherein the substrate (1) is a dense substrate made of at least one substrate material selected from silicon nitride, silicon carbide and aluminum nitride, and, as required, a thermal expansion buffer layer (8) is provided between the substrate (1) inclusive of at least part of the lower electrode layer (3) and the solid electrolyte layer (4), and the difference is not more than 5 ppm/° C. between the coefficient of thermal expansion of the solid electrolyte layer (4) and the coefficient of thermal expansion of the substrate (1) that comes in contact with at least part of the solid electrolyte layer (4) or of the thermal expansion buffer layer (8), and a method of producing the same.

### TECHNICAL FIELD

This invention relates to a laminated gas sensor, such as an oxygen sensor or a NOx sensor that detects specific gas components in the exhaust gas of an automobile, and to a method of producing the laminated gas sensor.

### BACKGROUND ART

In order to prevent air pollution, regulations against exhaust gases from automotive engines are becoming more strict year after year. As a means for decreasing harmful components in the exhaust gases, there have been employed a system that suppresses the generation of harmful components in the exhaust gas by controlling the combustion of the engine, and a system that learns the combusting condition of the engine from the oxygen concentration and the nitrogen oxide (NOx) concentration in the exhaust gas and feeds the combusting state back for controlling the fuel injection and the air-fuel ratio.

As such a concentration detector device, a laminated exhaust gas sensor in which a sensor unit and a heater unit are fabricated integrally together has now been widely used to substitute for the conventional cup-type gas sensors owing to its quick activating time and its feasibility for attaining high function as taught in, for example, JP-A-2006-023128.

Further, since the exhaust gas contains water produced by the combustion, the exhaust gas sensor is placed in an environment where it is exposed to water at all times. Therefore, the exhaust gas sensor that is used at temperatures of not lower than 500° C. must have a thermal shock resistance. However, the substrate for the exhaust gas sensor has now been made using alumina or zirconia which, usually, has a large coefficient of thermal expansion. Therefore, the exhaust gas sensor has a thermal shock resisting temperature of as low as 200° C., which is not desirable.

In order to improve the thermal shock resistance of the exhaust gas sensor, proposals have heretofore been made to form a protection coating such as of porous alumina on the uppermost surface of the exhaust gas sensor. JP-A-2001-281210 proposes a laminated gas detector device provided with a porous protection layer which covers at least a junction interface, that is exposed to a gas to be measured, of at least one surface of the surfaces on which the junction interfaces of a plurality of ceramic substrates are exposed, in an attempt to provide a laminated gas detector device which has a long life by preventing damage to the device itself that stems from the thermal shock caused by the adhesion of water droplets on the laminated gas detector device.

Further, JP-A-2003-322632 proposes a laminated gas sensor device having a porous protection layer, having a thickness of 20 μm or more from the corner portion, that covers at least a corner portion on the side close to a position where a resistance heating element is arranged among the corner portions extending in the lengthwise direction of the device body on at least the front end side of the device body that will be exposed to a gas to be measured, in an attempt to provide a laminated gas sensor device capable of preventing the occurrence of cracks in the plate-like device body obtained by laminating a detector layer on the substrate that has a resistance heating element, even when water droplets are brought into contact thereto.

However, with the exhaust gas sensors proposed above, resistance against exposure to water is still not sufficient and is accompanied by a problem of deteriorating sensor characteristics such as response characteristics, and a further improvement is desired.

There has, further, been proposed an exhaust gas sensor using cordierite having a low thermal expansion as a substrate. JP-A-2007-171118 proposes a gas sensor comprising a gas sensor unit and a substrate for supporting the gas sensor unit, the substrate being a ceramic substrate containing cordierite as a chief component and the ceramic substrate containing a mullite phase, in an attempt to provide a gas sensor equipped with a substrate having high thermal shock resistance and low thermal conductivity that can be produced at low cost, and an automotive vehicle equipped with the gas sensor.

However, the exhaust gas sensor proposed above has low thermal conductivity, and the sensor unit is not quickly heated by the heater, and therefore there is a problem of slow activation. Therefore, a further improvement is desired.

There has, further, been proposed an exhaust gas sensor using porous silicon nitride as a substrate. JP-A-2000-062077 proposes a composite material of a thin zirconia film obtained by forming a thin yttria-stabilized zirconia film on a trisilicon tetranitride porous sintered body which can be utilized for gas sensors for sensing oxygen, etc., and for fuel cells, in an attempt to efficiently form a thin yttria-stabilized zirconia film on a porous substrate and form a thin pin hole-free yttria-stabilized zirconia film.

However, the exhaust gas sensor proposed above is porous and is not strong and has insufficient thermal shock resistance accompanied by a problem of low thermal conductivity and slow activation. In addition, it is difficult to form a dense sensor unit on the surface thereof. Therefore, further improvement is desired.

There has, further, been proposed an exhaust gas sensor using dense silicon nitride as a substrate. JP-A-09-080012 proposes an oxygen sensor, which heats a cylindrical solid electrolyte by using a ceramic heater obtained by burying a heat-generating body in a ceramic substrate comprising chiefly silicon nitride having a heat capacity per a unit volume of not more than 0.60 cal/cm³·° C., a coefficient of thermal expansion of not more than 4.5×10⁻⁶/° C. and a flexural strength of not smaller than 50 kg/mm², in an attempt to obtain an oxygen sensor equipped with a ceramic heater which quickly heats the device and has excellent durability.

However, in the oxygen sensor proposed above, heat is poorly conducted since the substrate burying the heat-generating body therein has not been integrally fabricated with the cylindrical solid electrolyte, leaving a problem in regard to quickly elevating the temperature. Therefore, a further improvement is desired.

Further, JP-A-10-197476 proposes a limiting current-type oxygen sensor comprising a gas-impermeable and dense substrate of silicon carbide, silicon nitride or aluminum nitride, a lower electrode layer formed on the substrate, a gas-permeable, oxygen ion-conducting solid electrolyte layer formed so as to cover the lower electrode layer, and an upper electrode layer formed on the solid electrolyte layer, in an attempt to provide a limiting current-type oxygen sensor avoiding a problem that stems from the use of a gas-permeable porous substrate, that is suited for easy and mass production through decreased production steps without the need of forming a layer for determining the diffusion rate except electrodes and solid electrolyte layer, and which can be easily combined with the peripheral circuitry or other sensors.

However, the exhaust gas sensor using dense silicon nitride as the substrate proposed above has a gap, has a small strength in the gas-permeable solid electrolyte, has a large difference in the coefficient of thermal expansion between the solid electrolyte and the dense substrate such as of silicon nitride leaving excess of stress on the junction interface and making it difficult to satisfy thermal shock resistance or durability and reliably. Therefore, a further improvement is desired.

### SUMMARY OF INVENTIONS

The present invention was accomplished in view of the above conventional problems, and provides a laminated gas sensor for exhaust gases improving thermal shock resistance, durability and reliability without permitting characteristics of the exhaust gas sensor to be particularly lowered.

A first present invention provides a laminated gas sensor comprising a solid electrolyte layer (4) formed on one surface of a substrate (1) holding a lower electrode layer (3) therebetween, and an upper electrode layer (5) formed on the solid electrolyte layer (4), wherein the substrate (1) is a dense substrate made of at least one substrate material selected from silicon nitride, silicon carbide and aluminum nitride, and, as required, a thermal expansion buffer layer (8) is provided between the substrate (1) inclusive of at least part of the lower electrode layer (3) and the solid electrolyte layer (4), and a difference is not more than 5 ppm/° C. between the coefficient of thermal expansion of the solid electrolyte layer (4) and the coefficient of thermal expansion of the substrate (1) that comes in contact with at least part of the solid electrolyte layer (4) or of the thermal expansion buffer layer (8).

In the first invention of the application, the dense substrate made of at least one substrate material selected from silicon nitride, silicon carbide and aluminum nitride has low thermal expansion and great strength, and exhibits excellent thermal shock resistance and high thermal conductivity enabling the sensor to be quickly activated. Further, since the difference is not more than 5 ppm/° C. between the coefficient of thermal expansion of the solid electrolyte layer (4) and the coefficient of thermal expansion of the substrate (1) that comes in contact with at least part of the solid electrolyte layer (4) or of the thermal expansion buffer layer (8), stress can be decreased on the junction interface and, as a result, the gas sensor reliably features thermal shock resistance, durability and reliability. Upon forming a sensor device of a thin film structure on the surface of the substrate, therefore, the exhaust gas sensor exhibits greatly improved resistance against exposure to water. If the difference exceeds 5 ppm/° C. between the coefficient of thermal expansion of the solid electrolyte layer (4) and the coefficient of thermal expansion of the substrate (1) that comes in contact with at least part of the solid electrolyte layer (4) or of the thermal expansion buffer layer (8), stress increases on the junction interface causing the junction interface to be peeled off or cracked, which is not desirable.

As a preferred embodiment of the first invention, there can be exemplified the laminated gas sensor, wherein the substrate (1) has a coefficient of thermal expansion of not more than 5 ppm/° C. This embodiment makes it possible to more reliably obtain the thermal shock resistance of the gas sensor.

As another preferred embodiment of the first invention, there can be exemplified the laminated gas sensor, wherein at least part of the solid electrolyte layer (4) is in contact with part of the substrate (1). According to this embodiment, a difference is decreased to be not more than 5 ppm/° C. between the coefficient of thermal expansion of the solid electrolyte layer (4) and the coefficient of thermal expansion of the substrate (1), making it possible to more reliably obtain the thermal shock resistance of the gas sensor.

As a further preferred embodiment of the first invention, there can be exemplified the laminated gas sensor wherein the solid electrolyte layer (4) comprises a mixed crystal phase of a solid electrolyte material and a brittle material having a coefficient of thermal expansion of not more than 5 ppm/° C. According to this embodiment, a difference is easily decreased to be not more than 5 ppm/° C. between the coefficient of thermal expansion of the solid electrolyte layer (4) and the coefficient of thermal expansion of the substrate (1), making it possible to more reliably obtain the thermal shock resistance of the gas sensor.

As a further preferred embodiment of the first invention, there can be exemplified the laminated gas sensor wherein at least part of the solid electrolyte layer (4) is in contact with at least part of the thermal expansion buffer layer (8). According to this embodiment, a difference is decreased to be not more than 5 ppm/° C. between the coefficient of thermal expansion of the solid electrolyte layer (4) and the coefficient of thermal expansion of the thermal expansion buffer layer (8), making it possible to more reliably obtain the thermal shock resistance of the gas sensor.

As a further preferred embodiment of the first invention, there can be exemplified the laminated gas sensor wherein the thermal expansion buffer layer (8) has a coefficient of thermal expansion of 5 to 10 ppm/° C. According to this embodiment, a difference is easily decreased to be not more than 5 ppm/° C. between the coefficient of thermal expansion of the solid electrolyte layer (4) and the coefficient of thermal expansion of the thermal expansion buffer layer (8), making it possible to more reliably obtain the thermal shock resistance of the gas sensor.

As a further preferred embodiment of the first invention, there can be exemplified the laminated gas sensor wherein the thermal expansion buffer layer (8) comprises a mixed crystal phase of a solid electrolyte material and a brittle material having a coefficient of thermal expansion of not more than 5 ppm/° C. According to this embodiment, a difference is easily decreased to be not more than 5 ppm/° C. between the coefficient of thermal expansion of the solid electrolyte layer (4) and the coefficient of thermal expansion of the thermal expansion buffer layer (8), making it possible to more reliably obtain the thermal shock resistance of the gas sensor.

As a further preferred embodiment of the first invention, there can be exemplified the laminated gas sensor wherein the thermal expansion buffer layer (8) is provided in contact with part of the lower electrode layer (3) and part of the substrate (1). According to this embodiment, a difference is easily decreased to be not more than 5 ppm/° C. between the coefficient of thermal expansion of the solid electrolyte layer (4) and the coefficient of thermal expansion of the thermal expansion buffer layer (8) while maintaining characteristics of the gas sensor more favorably, making it possible to more reliably obtain the thermal shock resistance of the gas sensor.

In order to set the difference to be not more than 5 ppm/° C. between the coefficient of thermal expansion of the solid electrolyte layer (4) and the coefficient of thermal expansion of the substrate (1) contacting to at least part of the solid electrolyte layer (4) or of the thermal expansion buffer layer (8) as described above, use is made of the substrate (1) having a coefficient of thermal expansion of not more than 5 ppm/° C., and the coefficient of thermal expansion of the solid electrolyte layer (4) which is the upper layer contacting to the substrate (1) is allowed to be selected over a range of 5 to 10 ppm/° C. If the thermal expansion buffer layer (8) is positioned between the solid electrolyte layer (4) and the substrate (1), further, the coefficient of thermal expansion of the thermal expansion buffer layer (8) is selected to be 5 to 10 ppm/° C., making it possible to select the coefficient of thermal expansion of the solid electrolyte layer (4) over a wide range in which the difference thereof is not more than 5 ppm/° C. from the range of 5 to 10 ppm/° C.

As a still further preferred embodiment of the first invention, there can be exemplified the laminated gas sensor wherein a heater (7) is, further, provided on the other surface of the substrate (1), or in the substrate (1). According to this embodiment, the heater (7), the substrate (1) and the solid electrolyte layer are fabricated integrally together, enabling the temperature of the solid electrolyte layer to be quickly elevated and the sensor to be quickly activated.

As a still further preferred embodiment of the first invention, there can be exemplified the laminated gas sensor wherein a gas diffusion layer (6) is, further, provided on the solid electrolyte layer (4) holding the upper electrode layer (5) therebetween. According to this embodiment, the laminated gas sensor works as a limiting current type oxygen sensor to detect a change in the gas concentration.

A second invention of this application provides a method of producing a laminated gas sensor comprising a solid electrolyte layer (4) formed on one surface of a substrate (1) holding a lower electrode layer (3) therebetween, and an upper electrode layer (5) formed on the solid electrolyte layer (4), the method of producing a laminated gas sensor comprising the steps of:
forming the substrate (1) which is dense, by using at least one substrate material selected from silicon nitride, silicon carbide and aluminum nitride;
arranging the lower electrode layer (3) on part of one surface of the substrate (1);
forming the solid electrolyte layer (4) on the lower electrode layer (3) and on part of the surface of the substrate (1) on which the lower electrode layer (3) has not been arranged, relying on an aerosol deposition method, the solid electrolyte layer (4) having a coefficient of thermal expansion which is different by not more than 5 ppm/° C. from the coefficient of thermal expansion of the substrate (1); and
arranging the upper electrode layer (5) on part of the solid electrolyte layer (4).

In the second invention of this application, the dense substrate made of at least one substrate material selected from silicon nitride, silicon carbide and aluminum nitride has a low thermal expansion and a large strength, and exhibits excellent thermal shock resistance and high thermal conductivity enabling the sensor to be quickly activated. Further, since the difference is not more than 5 ppm/° C. between the coefficient of thermal expansion of the solid electrolyte layer (4) and the coefficient of thermal expansion of the substrate (1), it is possible to advantageously produce the laminated gas sensor which reliably features thermal shock resistance, durability and reliability as the gas sensor.

A third invention of the application provides a method of producing a laminated gas sensor comprising a solid electrolyte layer (4) formed on one surface of a substrate (1) holding a lower electrode layer (3) and a thermal expansion buffer layer (8) therebetween, and an upper electrode layer (5) formed on the solid electrolyte layer (4), the method of producing a laminated gas sensor comprising the steps of:
forming the substrate (1) which is dense by using at least one substrate material selected from silicon nitride, silicon carbide and aluminum nitride;
arranging the lower electrode layer (3) on part of one surface of the substrate (1);
forming the thermal expansion buffer layer (8) at least on part of the surface of the substrate (1) on where the lower electrode layer (3) has not been arranged, relying on an aerosol deposition method;
forming the solid electrolyte layer (4) on at least the thermal expansion buffer layer (8), the solid electrolyte layer (4) having a coefficient of thermal expansion which is different by not more than 5 ppm/° C. from the coefficient of thermal expansion of the thermal expansion buffer layer (8); and
arranging the upper electrode layer (5) on part of the solid electrolyte layer (4).

In the third invention of the application, too, the dense substrate made of at least one substrate material selected from silicon nitride, silicon carbide and aluminum nitride has a low thermal expansion and a large strength, and exhibits excellent thermal shock resistance and high thermal conductivity enabling the sensor to be quickly activated. Further, since the difference is not more than 5 ppm/° C. between the coefficient of thermal expansion of the solid electrolyte layer (4) and the coefficient of thermal expansion of the thermal expansion buffer layer (8), it is possible to advantageously produce the laminated gas sensor which reliably features thermal shock resistance, durability and reliability as the gas sensor.

As a preferred embodiment of the second invention, there can be exemplified the method of producing a laminated gas sensor wherein in the step of forming the solid electrolyte layer (4), use of fine crystal particles of the solid electrolyte material and fine crystal particles of the brittle material having a coefficient of thermal expansion of not more than 5 ppm/° C. to form the solid electrolyte layer (4) of a mixed crystal phase of the solid electrolyte material and the brittle material having a coefficient of thermal expansion of not more than 5 ppm/° C., relying on the aerosol deposition method is possible. According to this embodiment, the coefficient of thermal expansion of the solid electrolyte layer (4) can be set to be not more than 10 ppm/° C., and a difference of the coefficient of thermal expansion thereof from that of the substrate (1) can be easily decreased to be not more than 5 ppm/° C.

As a preferred embodiment of the third invention, there can be exemplified the method of producing a laminated gas sensor wherein in the step of forming the thermal expansion buffer layer (8), use of fine crystal particles of the solid electrolyte material and fine crystal particles of the brittle material having a coefficient of thermal expansion of not more than 5 ppm/° C. to form the thermal expansion buffer layer (8) of a mixed crystal phase of the solid electrolyte material and the brittle material having a coefficient of thermal expansion of not more than 5 ppm/° C., relying on the aerosol deposition method is possible. According to this embodiment, the coefficient of thermal expansion of the thermal expansion buffer layer (8) can be set to be not more than 5 to 10 ppm/° C., and a difference of the coefficient of thermal expansion thereof from those of the substrate (1) and the solid electrolyte layer (4) can be easily decreased to be not more than 5 ppm/° C.

As another preferred embodiment of the third invention, there can be exemplified the method of producing a laminated gas sensor wherein in the step of forming the thermal expansion buffer layer (8), the thermal expansion buffer layer (8) is formed on part of the surface of the substrate (1) on where the lower electrode layer (3) has not been arranged, and on part of the lower electrode layer (3). According to this embodiment, only the solid electrolyte layer (4) having a coefficient of thermal expansion of 10 ppm/° C. and a high ion conductivity is formed on most of the upper portion of the lower electrode layer (3), and is joined to the substrate (1) holding the thermal expansion buffer layer (8) therebetween, making it possible to improve both the sensor characteristics and the thermal shock resistance.

As a further preferred embodiment of the second invention and the third invention, there can be exemplified the method of producing a laminated gas sensor, further including the step of arranging a heater (7) on the other surface of the substrate (1) or in the substrate (1). According to this embodiment, the heater, the substrate and the solid electrolyte layer are fabricated integrally together, improving the conduction of heat and enabling the sensor to be quickly activated.

As a further preferred embodiment of the second invention and the third invention, there can be exemplified the method of producing a laminated gas sensor, further including the step of arranging gas a diffusion layer (6) on the solid electrolyte layer (4) holding the upper electrode layer (5) therebetween. According to this embodiment, the laminated gas sensor can work as a limiting current type oxygen sensor to detect a change in the gas concentration.

According to the methods of producing a laminated gas sensor of the inventions, the films can be formed, maintaining the crystal phase of the starting ceramic particles. In the laminated gas sensor of the inventions, further, a solid electrolyte film is formed on the substrate that has a coefficient of thermal expansion of as small as not more than 5 ppm/° C., by using a mixed powder of a ceramic powder that has a difference in the coefficient of thermal expansion of not more than 5 ppm/° C. from that of the solid electrolyte, in order to decrease the stress caused by a difference in the coefficient of thermal expansion from that of the solid electrolyte such as yttria-stabilized zirconia (YSZ) that has a coefficient of thermal expansion of not less than 10 ppm/° C.

Further, the stress can be decreased, even by forming, as an intermediate buffer layer, the thermal expansion buffer layer by using the mixed powder of the ceramic powder that has a difference in the coefficient of thermal expansion of not more than 5 ppm/° C. from that of the solid electrolyte. Further, upon forming the above thermal expansion buffer layer on only the interface of the end portion of the electrode layer and substrate portion, and the solid electrolyte layer, it is allowed to decrease the stress without deteriorating the gas sensor characteristics.

### BRIEF DESCRIPTION OF THE DRAWINGS

FIG. 1 shows a view schematically illustrating a gas sensor of the invention.

FIG. 2 shows a view schematically illustrating the gas sensor of the invention in cross section along A-A′ in FIG. 1.

FIG. 3 shows a view schematically illustrating the gas sensor of the invention in cross section along A-A′ in FIG. 1.

### DETAILED DESCRIPTION

The substrate 1 in the laminated gas sensor of the invention is a dense substrate comprising at least one kind of substrate material selected from silicon nitride, silicon carbide and aluminum nitride. Among them, silicon nitride and silicon carbide are preferred and, particularly, silicon nitride is preferred from the standpoint of a large strength at high temperatures. Further, the substrate 1, usually, has a coefficient of thermal expansion of not more than 7 ppm/° C. and, preferably, has a coefficient of thermal expansion of not more than 5 ppm/° C. from the standpoint of thermal shock resistance.

The substrate 1 has a thickness of, usually, 0.1 to 5 mm and, more preferably, 0.2 to 2 mm. Further, the substrate 1 is, usually, obtained by a method of firing a sheet that is formed by a doctor blade method.

If the solid electrolyte layer 4 is to be brought into direct contact with the substrate 1, it is desired that its coefficient of thermal expansion is different from the coefficient of thermal expansion of the substrate 1 by not more than 5 ppm/° C. As the solid electrolyte layer 4 having a coefficient of thermal expansion larger than the coefficient of thermal expansion of the substrate 1 by not more than 5 ppm/° C., for example, there can be exemplified the one having a coefficient of thermal expansion of, preferably, 5 to 10 ppm/° C., and particularly preferably, 5 to 8 ppm/° C. More concretely, there can be exemplified the one comprising a mixed crystal phase of a solid electrolyte material and a brittle material having a coefficient of thermal expansion of not more than 5 ppm/° C.

Concrete examples of the solid electrolyte material include yttria-stabilized zirconia, calcia-stabilized zirconia, magnesia-stabilized zirconia and ceria-stabilized zirconia. Among them, yttria-stabilized zirconia is preferred. Concrete examples of the brittle material having coefficients of thermal expansion of not more than 5 ppm/° C. may include silicon nitride, silicon carbide, aluminum nitride, mullite and cordierite.

The solid electrolyte material is mixed into the brittle material having the coefficient of thermal expansion of not more than 5 ppm/° C. at a ratio of 50.0% to 99.0% and, particularly preferably, 70.0 to 99.0%. Further, it is desired that the solid electrolyte material has a crystal size of, usually, 0.01 to 5.0 μm, while the brittle material having the coefficient of thermal expansion of not more than 5 ppm/° C. has a crystal size of, usually, 0.01 to 5 μm.

If the solid electrolyte layer 4 is not in direct contact with the substrate 1, but is present via the thermal expansion buffer layer 8 and is not in direct contact with the substrate 1, then a material having a coefficient of thermal expansion which is different from the coefficient of thermal expansion of the substrate 1 by more than 5 ppm/° C. may be used. In such a case, it is desired that the solid electrolyte layer 4 has a coefficient of thermal expansion that is different from the coefficient of thermal expansion of the thermal expansion buffer layer 8 by not more than 5 ppm/° C.

The above solid electrolyte layer 4 may comprise a mixed crystal phase of the solid electrolyte material and the brittle material having a coefficient of thermal expansion of not more than 5 ppm/° C., or may comprise a solid electrolyte material that is usually used, such as zirconia (ZrO₂). As the zirconia layer which is the solid electrolyte layer, there is usually used an yttria-stabilized zirconia in which yttria (Y₂O₃) is solidly dissolved.

Further, the solid electrolyte layer 4 has a thickness of, usually, 1 to 100 μm and, more preferably, 2 to 20 μm. Further, the solid electrolyte layer 4 is formed by, for example, an aerosol deposition method that will be described later.

It is desired that the thermal expansion buffer layer 8 has a coefficient of thermal expansion which is different from the coefficient of thermal expansion of the solid electrolyte layer 4 by not more than 5 ppm/° C. Desirably, the thermal expansion buffer layer 8 has a coefficient of thermal expansion of 5 to 10 ppm/° C. and, particularly, 6 to 8 ppm/° C. More concretely, the one comprising a mixed crystal phase of the solid electrolyte material and the brittle material having a coefficient of thermal expansion of not more than 5 ppm/° C. can be used. Concrete examples of the solid electrolyte material include yttria-stabilized zirconia, calcia-stabilized zirconia, magnesia-stabilized zirconia and ceria-stabilized zirconia. Among them, the yttria-stabilized zirconia is preferred. Further, concrete examples of the brittle material having a coefficient of thermal expansion of not more than 5 ppm/° C. include silicon nitride, silicon carbide, aluminum nitride, mullite and cordierite. The ratio of mixing the solid electrolyte material into the brittle material having the coefficient of thermal expansion of not more than 5 ppm/° C. is, preferably, 10.0 to 90.0% and, particularly, 30.0 to 70.0%. Further, it is desired that the solid electrolyte material has a crystal size of, usually, 0.01 to 5.0 μm, while the brittle material having the coefficient of thermal expansion of not more than 5 ppm/° C. has a crystal size of, usually, 0.01 to 5 μm.

In addition, the thermal expansion buffer layer 8 has a thickness of, usually, 0.1 to 10 μm and, more preferably, 1 to 5 μm. Further, the thermal expansion buffer layer 8 is formed by, for example, an aerosol deposition method that will be described later.

The lower electrode layer 3 (a reference electrode) is an ordinary lower electrode layer without any particular limitation. More concretely, the lower electrode layer 3 comprises platinum (Pt) or the like and has a thickness of, usually, 0.1 to 5 μm.

The upper electrode layer 5 (a measuring electrode) is an ordinary upper electrode layer without any particular limitation. More concretely, the upper electrode layer 5 comprises platinum (Pt) or the like and has a thickness of, usually, 0.1 to 5 μm.

The gas diffusion layer 6 is an ordinary gas diffusion layer without any particular limitation. More concretely, the gas diffusion layer 6 comprises silicon nitride, cordierite or alumina, and has a thickness of, usually, 1 to 100 μm.

The heater 7 is to enable the gas sensor to be used, maintaining high sensitivity and stability in any temperature environment of from room temperature up to about 1000° C., and is arranged on the back surface of the substrate 1 or in the substrate 1. The heater 7 comprises a platinum (Pt) layer or a molybdenum (Mo) formed in any desired shape, and has a thickness of, usually, 1 to 10 μm.

The gas diffusion layer 6 is to enable the gas to be measured to be diffused and arrive at the upper electrode layer 5 (a measuring electrode). Concrete examples thereof are film-like gas diffusion layers comprising silicon nitride, cordierite or alumina.

The aerosol deposition method employed by the method of producing a laminated gas sensor of the invention comprises injecting an aerosol of a gas in which fine particles of ceramics are dispersed through a nozzle onto, for example, the substrate 1 and the lower electrode layer 3 so that the fine particles collide with the substrate 1 and the lower electrode layer 3, and that the fine particles are joined thereto due to the impact of collision. This makes it possible to form the solid electrolyte layer 4 of a thin film comprising a fine particulate material directly on the substrate 1 and the lower electrode layer 3, without requiring any particular heating means, and at normal temperature. The processing according to the aerosol deposition method is conducted at normal temperature, and the film is formed at a temperature sufficiently lower than a melting point of the fine particulate material, i.e., formed at not higher than several hundred degrees centigrade.

The ceramic is usually sintered by being heated to a temperature near its melting point. However, according to the present invention, the thin film is formed by utilizing the energy of collision onto the base material, making it possible to omit the step of sintering at high temperatures and offering an advantage from the standpoint of productivity. Compared to the case of forming the thin film by sputtering, further, the present invention excels in productivity since it requires a low degree of vacuum and forms the film in short periods of time.

More concretely, the aerosol deposition method is conducted under such conditions that the processing temperature is, usually, from room temperature to 400° C. or, more desirably, from room temperature to 100° C., fine particles of ceramics have crystal sizes of, usually, 0.01 to 10 μm and, more preferably, 0.1 to 5 μm, and the processing gas is, usually, air, nitrogen gas, helium gas or the like.

A device employed for the aerosol deposition method, usually, comprises an aerosol generator for generating an aerosol, and a nozzle for injecting the aerosol onto the substrate, and includes position control means for moving and swinging the base material and the nozzle relative to each other when it is attempted to produce a structure having an area larger than the aperture of the nozzle, or includes a chamber for forming the structure and a vacuum pump when the production is conducted under reduced pressure, and, further, includes a gas source for generating the aerosol.

In the invention, the coefficient of thermal expansion, e.g., “the coefficient of thermal expansion of 1 ppm/° C.” stands for that the volume of an object expands at a ratio of 1/10⁶ as the temperature varies by 1° C. As the device for measuring the coefficient of thermal expansion, there is usually used a laser speckle strain meter, and the measurement is taken, usually, under a condition of 40° C. to 800° C.

In the invention, the word “dense” means that the porosity is not more than 5%. Further, the substrate which is dense can be confirmed, usually, by measuring the specific gravity, by inspecting a solution that has penetrated or by the observation using a scanning electron microscope.

In the invention, the “brittle material” concretely means that the material is ceramics.

### EXAMPLES

The invention will now be described more concretely by way of embodiments to which only, however, the invention is in no way limited.

### Embodiment 1

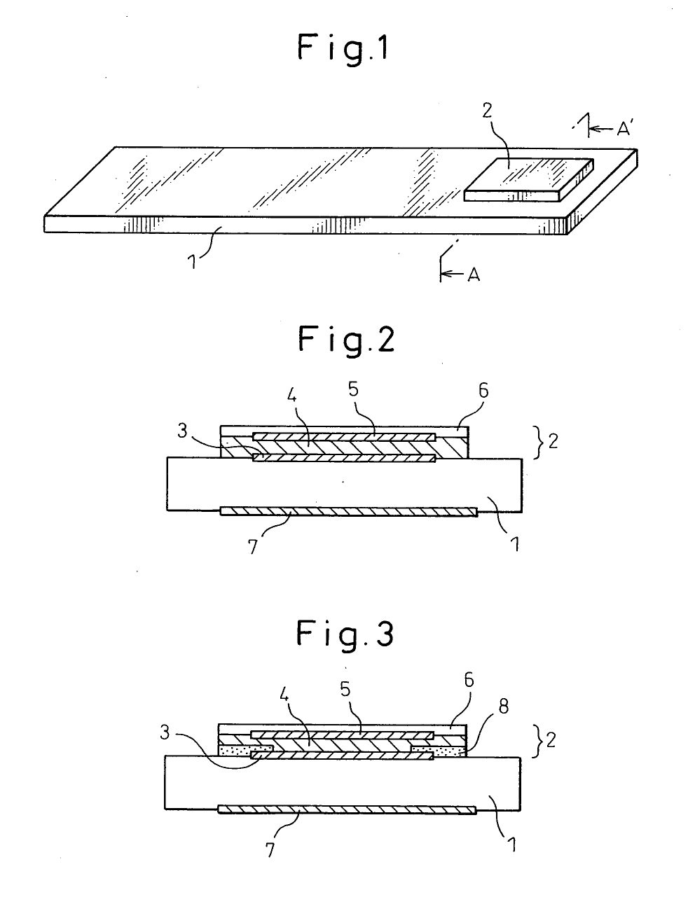

FIG. 1 schematically illustrates an embodiment of a laminated gas sensor comprising a substrate 1 and a gas sensor unit 2 formed thereon and having a total thickness of, usually, 0.1 to 5 mm and, more preferably, 0.2 to 3 mm, and FIG. 2 more concretely and schematically illustrates the embodiment 1 of the laminated gas sensor of the invention in cross section along A-A′ in FIG. 1. In other words, referring to FIG. 2, a lower electrode layer 3 is provided on a portion of one surface of the substrate 1, a solid electrolyte layer 4 is provided on the lower electrode layer 3 and on a portion of the substrate 1 on which the lower electrode layer 3 has not been arranged, and an upper electrode layer 5 is provided on a portion of the solid electrolyte layer 4. Further, a gas diffusion layer 6 is provided on the upper electrode layer 5 and on the solid electrolyte layer 4 on which the upper electrode layer 5 has not been arranged. In addition, a heater 7 is provided on a portion of the other surface of the substrate 1 in FIG. 2. Here, a difference is not more than 5 ppm/° C. between the coefficient of thermal expansion of the solid electrolyte layer 4 and the coefficient of thermal expansion of the substrate 1 which is the lower layer in contact thereto.

### Embodiment 2

FIG. 3 more concretely and schematically illustrates Embodiment 2 of the laminated gas sensor of the invention in cross section along A-A′ in FIG. 1. In other words, referring to FIG. 3, the lower electrode layer 3 is provided on a portion of one surface of the substrate 1, a thermal expansion buffer layer 8 is provided on a peripheral end portion of the lower electrode layer 3 and on a portion of the substrate 1, the solid electrolyte layer 4 is provided on the thermal expansion buffer layer 8 and on the lower electrode layer 3 on which the thermal expansion buffer layer 8 has not been arranged, and the upper electrode layer 5 is provided on a portion of the solid electrolyte layer 4. Further, the gas diffusion layer 6 is provided on the upper electrode layer 5 and on the solid electrolyte layer 4 on which the upper electrode layer 5 has not been arranged. Moreover, the heater 7 is provided on a portion of the other surface of the substrate 1 in FIG. 3. The difference is not more than 5 ppm/° C. between the coefficient of thermal expansion of the solid electrolyte layer 4 and the coefficient of thermal expansion of the thermal expansion buffer layer 8 which is the lower layer in contact thereto.

### Example 1

A commercially available silicon nitride substrate (Toshiba Ceramic TSN-90, coefficient of thermal expansion of 3.4 ppm/° C.) was cut into a shape of 4 mm×40 mm, and the end surfaces thereof were polished to prepare a sensor substrate. A Pt heater layer was formed on one surface thereof, and a first Pt electrode layer in a square shape having a side of 1 mm and a measuring lead electrode were formed on the other surface thereof. By using a fine particulate mixed powder of 80% of a starting yttria-stabilized zirconia powder and 20% of a starting silicon nitride powder, a solid electrolyte layer was formed in a square shape having a side of 2 mm at a thickness of 10 μm by the aerosol deposition method so as to cover the whole surface of the first Pt electrode layer. The film was formed by the aerosol deposition method under the conditions of introducing a helium gas into the starting fine particles at a rate of 10 liters per minute to obtain an aerosol of the starting fine particles, introducing the aerosol, through a nozzle, into a film-forming chamber in which the pressure has been reduced, and injecting the aerosol onto the silicon nitride substrate that was installed facing the nozzle. The pressures at the time of forming the film were 30 kPa in the chamber for forming the aerosol, and 0.2 kPa in the film-forming chamber. The coefficient of thermal expansion of the solid electrolyte layer was evaluated by the laser speckle method to be 7.8 ppm/° C., and the difference from the coefficient of thermal expansion of the silicon nitride substrate was 4.4 ppm/° C.

Next, a second Pt electrode layer in a square shape having a side of 1.5 mm and a measuring lead electrode were formed on the upper surface of the solid electrolyte layer. The thus prepared sample was evaluated for its thermal shock resistance (resistance against exposure to water). The method of evaluation was such that an electric current was supplied to the heater electrode so that the solid electrolyte layer was heated at 800° C. as measured by using a radiation thermometer. In this state, the sample was dipped in water maintained at room temperature and, thereafter, supply of the electric current was discontinued, and the sample was taken out. The sample was dipped in a penetration check solution for evaluating cracks. Thereafter, the penetration solution was wiped off, and the presence of cracks was observed and evaluated by using a stereoscopic microscope. The result showed that no cracking or peeling had been developed in the silicon nitride substrate or in the solid electrolyte layer.

### Comparative Example 1

A commercially available alumina substrate (A476, coefficient of thermal expansion of 7.9 ppm/° C.) was cut into a shape of 4 mm×40 mm, and the end surfaces thereof were polished to prepare a sensor substrate. A Pt heater layer was formed on one surface thereof, and a first Pt electrode layer in a square shape having a side of 1 mm and a measuring lead electrode were formed on the other surface thereof. By using a fine particulate powder of 100% of a starting yttria-stabilized zirconia powder, a solid electrolyte layer was formed in a square shape having a side of 2 mm at a thickness of 10 μm by the aerosol deposition method so as to cover the whole surface of the first Pt electrode layer. The film was formed by the aerosol deposition method under the conditions of introducing a helium gas into the starting fine particles at a rate of 10 liters per minute to obtain an aerosol of the starting fine particles, introducing the aerosol, through a nozzle, into a film-forming chamber in which the pressure has been reduced, and injecting the aerosol onto the alumina substrate that was installed facing the nozzle. The pressures at the time of forming the film were 30 kPa in the chamber for forming the aerosol, and 0.2 kPa in the film-forming chamber. The coefficient of thermal expansion of the solid electrolyte layer was evaluated by the laser speckle method to be 10.5 ppm/° C., and the difference from the coefficient of thermal expansion of the alumina substrate was 2.6 ppm/° C.

Next, a second Pt electrode layer in a square shape having a side of 1.5 mm and a measuring lead electrode were formed on the upper surface of the solid electrolyte layer. The thus prepared sample was evaluated for its thermal shock resistance (resistance against exposure to water). The method of evaluation was such that an electric current was supplied to the heater electrode so that the solid electrolyte layer was heated at 250° C. as measured by using a radiation thermometer. In this state, the sample was dipped in water maintained at room temperature and, thereafter, supply of the electric current was discontinued, and the sample was taken out. The sensor was dipped in the penetration check solution for evaluating clacks. Thereafter, the penetration solution was wiped off, and the presence of cracks was observed and evaluated by using a stereoscopic microscope. As a result, large cracks were observed in the alumina substrate and in the solid electrolyte layer.

We claim:

1. A laminated gas sensor comprising a solid electrolyte layer (4) formed on one surface of a substrate (1) holding a lower electrode layer (3) therebetween, and an upper electrode layer (5) formed on said solid electrolyte layer (4), wherein said substrate (1) is a dense substrate made of at least one substrate material selected from silicon nitride, silicon carbide and aluminum nitride, and as required, a thermal expansion buffer layer (8) is provided between said substrate (1) inclusive of at least part of said lower electrode layer (3) and said solid electrolyte layer (4), and a difference is not more than 5 ppm/° C. between the coefficient of thermal expansion of said solid electrolyte layer (4) and the coefficient of thermal expansion of said substrate (1) that comes in contact with at least part of said solid electrolyte layer (4) or of said thermal expansion buffer layer (8).

2. The laminated gas sensor according to claim 1, wherein said substrate (1) has a coefficient of thermal expansion of not more than 5 ppm/° C.

3. The laminated gas sensor according to claim 1, wherein at least part of said solid electrolyte layer (4) is in contact with part of said substrate (1).

4. The laminated gas sensor according to claim 3, wherein said solid electrolyte layer (4) comprises a mixed crystal phase of a solid electrolyte material and a brittle material having a coefficient of thermal expansion of not more than 5 ppm/° C.

5. The laminated gas sensor according to claim 1, wherein at least part of said solid electrolyte layer (4) is in contact with at least part of said thermal expansion buffer layer (8).

6. The laminated gas sensor according to claim 5, wherein said thermal expansion buffer layer (8) has a coefficient of thermal expansion of 5 to 10 ppm/° C.

7. The laminated gas sensor according to claim 6, wherein said thermal expansion buffer layer (8) comprises a mixed crystal phase of a solid electrolyte material and a brittle material having a coefficient of thermal expansion of not more than 5 ppm/° C.

8. The laminated gas sensor according to claim 5, wherein said thermal expansion buffer layer (8) is provided in contact with part of said lower electrode layer (3) and part of said substrate (1).

9. The laminated gas sensor according to claim 1, wherein a heater (7) is, further, provided on the other surface of said substrate (1) or in said substrate (1).

10. The laminated gas sensor according to claim 1, wherein a gas diffusion layer (6) is, further, provided on said solid electrolyte layer (4) holding said upper electrode layer (5) therebetween.

11. A method of producing a laminated gas sensor comprising a solid electrolyte layer (4) formed on one surface of a substrate (1) holding a lower electrode layer (3) therebetween, and an upper electrode layer (5) formed on said solid electrolyte layer (4), the method of producing a laminated gas sensor comprising the steps of:
forming said substrate (1) which is dense, by using at least one substrate material selected from silicon nitride, silicon carbide and aluminum nitride;
arranging the lower electrode layer (3) on part of one surface of said substrate (1);
forming said solid electrolyte layer (4) on said lower electrode layer (3) and on part of the surface of said substrate (1) on which said lower electrode layer (3) has not been arranged, relying on an aerosol deposition method, said solid electrolyte layer (4) having a coefficient of thermal expansion which is different by not more than 5 ppm/° C. from the coefficient of thermal expansion of said substrate (1); and
arranging said upper electrode layer (5) on part of said solid electrolyte layer (4).

12. A method of producing a laminated gas sensor comprising a solid electrolyte layer (4) formed on one surface of a substrate (1) holding a lower electrode layer (3) and a thermal expansion buffer layer (8) therebetween, and an upper electrode layer (5) formed on said solid electrolyte layer (4), the method of producing a laminated gas sensor comprising the steps of:
forming the substrate (1) which is dense by using at least one substrate material selected from silicon nitride, silicon carbide and aluminum nitride;
arranging the lower electrode layer (3) on part of one surface of said substrate (1);
forming said thermal expansion buffer layer (8) at least on part of the surface of said substrate (1) on which said lower electrode layer (3) has not been arranged, relying on an aerosol deposition method;
forming said solid electrolyte layer (4) on at least said thermal expansion buffer layer (8), said solid electrolyte layer (4) having a coefficient of thermal expansion which is different by not more than 5 ppm/° C. from the coefficient of thermal expansion of said thermal expansion buffer layer (8); and
arranging said upper electrode layer (5) on part of said solid electrolyte layer (4).

13. The method of producing a laminated gas sensor according to claim 11, wherein in the step of forming said solid electrolyte layer (4), use is made of fine crystal particles of said solid electrolyte material and fine crystal particles of the brittle material having a coefficient of thermal expansion of not more than 5 ppm/° C. to form said solid electrolyte layer (4) of a mixed crystal phase of said solid electrolyte material and the brittle material having a coefficient of thermal expansion of not more than 5 ppm/° C., relying on the aerosol deposition method.

14. The method of producing a laminated gas sensor according to claim 12, wherein in the step of forming said thermal expansion buffer layer (8), use is made of fine crystal particles of said solid electrolyte material and fine crystal particles of the brittle material having a coefficient of thermal expansion of not more than 5 ppm/° C. to form said thermal expansion buffer layer (8) of a mixed crystal phase of said solid electrolyte material and the brittle material having a coefficient of thermal expansion of not more than 5 ppm/° C., relying on the aerosol deposition method.

15. The method of producing a laminated gas sensor according to claim 12, wherein in the step of forming said thermal expansion buffer layer (8), said thermal expansion buffer layer (8) is formed on part of the surface of said substrate (1) on which said lower electrode layer (3) has not been arranged, and on part of said lower electrode layer (3).

16. The method of producing a laminated gas sensor according to claim 11, further including the step of arranging a heater (7) on the other surface of said substrate (1) or in said substrate (1).

17. The method of producing a laminated gas sensor according to claim 12, further including the step of arranging a heater (7) on the other surface of said substrate (1) or in said substrate (1).

18. The method of producing a laminated gas sensor according to claim 11, further including the step of arranging a gas diffusion layer (6) on said solid electrolyte layer (4) holding said upper electrode layer (5) therebetween.

19. The method of producing a laminated gas sensor according to claim 12, further including the step of arranging a gas diffusion layer (6) on said solid electrolyte layer (4) holding said upper electrode layer (5) therebetween.
